(19) United States
(12) Patent Application Publication
(10) Pub. No.: US 2008/0169364 A1
(43) Pub. Date: Jul. 17, 2008

(54) WELDED FUEL INJECTOR ATTACHMENT

(76) Inventors: Michael J. Zdroik, Metamora, MI (US); David C. Stieler, Lake Orion, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/622,224

(22) Filed: Jan. 11, 2007

(51) Int. Cl. F02M 61/16

(52) U.S. Cl. 239/533.2

(57) ABSTRACT

The present invention is directed towards a vehicular fuel delivery system. In accordance with one exemplary embodiment of the invention, the fuel delivery system includes a fuel rail having at least one feed, and at least one fuel injector assembly comprising a fuel injector and an outer housing. In accordance with this embodiment of the invention, the fuel injector assembly is permanently affixed to the fuel rail so that the feed of the fuel rail is in fluid communication with an inlet of the fuel injector, wherein at least a portion of the fuel injector assembly is configured to be replaceable.

### FIELD OF THE INVENTION

The field of the present invention is fuel delivery systems. More particularly, the present invention relates to a fuel delivery system for vehicular applications comprising one or more fuel injector assemblies, at least a portion of which are affixed to a fuel rail of the fuel delivery system.

### BACKGROUND OF THE INVENTION

Fuel delivery systems for fuel-injected engines used in various types of on-road and off-road vehicles typically include one or more fuel rails having a plurality of fuel injectors associated therewith. In many known fuel delivery systems, one or more fuel rails are provided which include a plurality of apertures in which injector sockets or cups are affixed. The fuel injectors are then inserted into the injector cups so as to allow for the fuel flowing in the fuel rail to be communicated to the fuel injectors. The fuel communicated from the fuel rail to the fuel injectors is then typically injected into an intake manifold or the like.

In many of these systems, the fuel injector cups are separate from the fuel rail, but affixed thereto using known attachment methods. For example, the injector cup may have a neck portion that extends into the aperture in the fuel rail and beyond the inside surface of the fuel rail. In this instance, the cup can be affixed to the rail by performing known attachment methods such as peening, swaging, staking or otherwise expanding the portion of the neck extending into the fuel rail to resist removal of the cup from the fuel rail, while at the same time creating a substantially fluid-tight seal. In other systems, the cup may be affixed to the fuel rail by way of a brazing process or the like.

In any event, one or more O-rings are often required in order to prevent or at least reduce potential leak paths and hydrocarbon permeation paths between, for example, the injector cup and the fuel injector disposed therein. While these systems have proven to work, they are not without their disadvantages. For example, the need for O-rings and precision sealing surfaces in these systems adds costs to the overall system. Additionally, these systems have not optimally reduced the permeation of hydrocarbons from the system.

Accordingly, there is a need for a fuel delivery system that will minimize and/or eliminate one or more of the above-identified deficiencies.

### SUMMARY OF THE INVENTION

The present invention is directed towards a vehicular fuel delivery system. In accordance with one exemplary embodiment of the invention, the fuel delivery system includes a fuel rail having at least one feed, and at least one fuel injector assembly comprising a fuel injector and an outer housing. In accordance with this embodiment of the invention, the fuel injector assembly is permanently affixed to the fuel rail so that the feed of the fuel rail is in fluid communication with an inlet of the fuel injector, and wherein at least a portion of the fuel injector assembly is further configured to be replaceable. Further features and advantages of the present invention will become more apparent to those skilled in the art after a review of the invention as it is shown in the accompanying drawings and detailed description.

### BRIEF DESCRIPTION OF THE DRAWINGS

FIG. 1 is a perspective view of a fuel delivery system in general form in accordance with the present invention having a polymer coated tube as a fuel rail.

FIG. 2 is a cross-section view of the polymer coated tube taken substantially along the lines 2-2 in FIG. 1.

FIG. 3 is a partial cross-section view of a preferred embodiment of the fuel delivery system of FIG. 1 taken substantially along the lines 3-3 in FIG. 1, shown in an initial installation condition.

FIG. 4 is the partial cross-section view of the preferred embodiment of the fuel delivery system shown in FIG. 3 with the fuel injector assembly removed therefrom.

FIG. 5 is a side view of a preferred embodiment of a fuel injector assembly in accordance with the present invention.

FIG. 6 is a side view of an alternate preferred embodiment of a fuel injector assembly in accordance with the present invention.

FIG. 7 is a partial cross-section view of an alternate preferred embodiment of the fuel delivery system of FIG. 1 taken substantially along the lines 7-7 in FIG. 1, shown in an initial installation condition.

FIG. 8 is the partial cross-section view of the alternate preferred embodiment of the fuel delivery system shown in FIG. 7 with a portion of the fuel injector assembly removed therefrom.

FIG. 9 is a flow diagram of a method of manufacturing a fuel delivery system in accordance with the present invention.

### DETAILED DESCRIPTION OF PREFERRED EMBODIMENTS

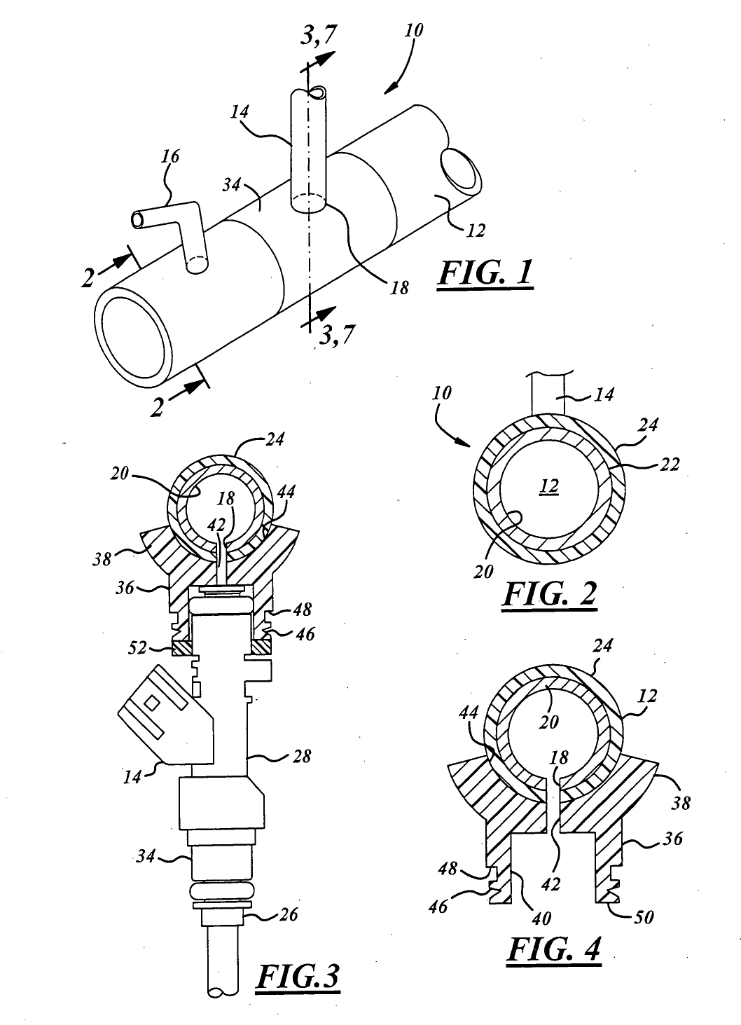

Referring now to the drawings wherein like reference numerals are used to identify identical components in the various views, FIG. 1 illustrates one exemplary embodiment of an assembled fuel delivery system 10 for a vehicular fuel-injected internal combustion engine in accordance with the present invention. In its most general form, fuel delivery system 10 includes a fuel rail 12 and at least one fuel injector assembly 14 coupled with fuel rail 12.

Fuel rail 12 is configured to communicate pressurized fuel from a fuel source (not shown) to one or more fuel injectors coupled thereto, which then injects the fuel into the intake manifold of the fuel injected engine associated therewith. As shown in FIG. 1, fuel rail 12 includes a supply port 16, as well as a series of feeds 18. Supply 16 allows fuel rail 12 to receive pressurized fuel from a fuel pump (not shown). As will be described in greater detail below, each feed 18 is configured to allow for the communication of the fuel within fuel rail 12 to an inlet of the corresponding fuel injector of the respective fuel injector assembly 14 associated therewith.

With reference to FIGS. 1 and 2, fuel rail 12 may take on a number of shapes and constructions. In a preferred embodiment, fuel rail 12 takes the form of a cylindrical tube (as shown). However, in other alternate embodiments, fuel rail 12 may take on other shapes, such as, for example, a rectangular tube. Similarly, in a preferred embodiment, fuel rail 12 has a one-piece unitary construction, however, in alternate embodiments, fuel rail 12 may be have a multiple piece construction wherein the various pieces are affixed together to form fuel rail 12. Thus, it will be appreciated by one of ordinary skill in the art that the present invention can be implemented using fuel rails 12 having various shapes and constructions. Additionally, fuel rail 12 may be formed of one or more of a number of materials, such as, for exemplary purposes only, sheet metal, high-temperature tolerant polymeric plastic material, or a polymer coated metal tube. In one exemplary embodiment, fuel rail 12 is a tube comprising aluminum material. In an another exemplary embodiment shown in FIGS. 1 and 2, fuel rail 12 is a thermoplastic coated tube comprising aluminum material. In this embodiment, fuel rail 12 includes an extruded core 20 comprising aluminum material, an interface layer 22, and a coating layer 24 comprising a thermoplastic material.

In one preferred embodiment, core 20 is comprised of an aluminum alloy, such as, for exemplary purposes only, 3000 series aluminum (i.e., manganese is the major alloying component), 5000 series aluminum (i.e., magnesium is the major alloying component), or 6000 series aluminum (i.e., magnesium and silicon are the major alloying components). Accordingly, core 20 can take the form of many different materials of which aluminum is a part, including, but not limited to, those identified with particularity above. Additionally, in the embodiment wherein fuel rail 12 is a tube comprising aluminum material, the aluminum material may be, for exemplary purposes only, any one of the aluminum alloys described above, however, the present invention is not so limited.

As with core 20, coating layer 24 can be comprised of one of many different types of thermoplastic material. In one preferred embodiment layer 24 is comprised of “polyamide 12” (commonly known in the art as “PA 12” or “nylon 12”). However, any suitable thermoplastic coating can be used. For example, in alternate embodiments, layer 24 is formed of “polyamide 6”, “polyamide 6.6”, “polyamide 11”, polyphenylene sulfide (PPS), polyphthalamide (PPA), or polybutylene napthalate (PBN), for example. It should be noted, however, that this list is meant to be for exemplary purposes only and not intended to be all inclusive. Accordingly, those of ordinary skill in the art will recognize that other thermoplastic materials can be used to create coating layer 24. As will be described in greater detail below, the thermoplastic layer 24 of fuel rail 12 is provided, at least in part, to facilitate a strong bond between fuel rail 12 and fuel injector assembly 14 when they are affixed together. An example of a commercially available thermoplastic coated tube that is suitable for use in the present invention is that offered by Hydro Aluminum Precision Tubing of Tonder, Denmark, under the trademark HYCOT®.

As will be described in greater detail below, fuel injector assembly 14 generally includes a fuel injector 26 and an outer housing 28 in which fuel injector 26 is disposed. Fuel injector 26 includes an inlet 30 at one end, an outlet or nozzle 32 at the other end, and a flow channel 34 therebetween for communicating fuel from inlet 30 to outlet 32. As will be described in greater detail below, inlet 30 of each respective fuel injector is configured to be in fluid communication with a respective feed 18 of fuel rail 12. This arrangement allows for the fuel in fuel rail 12 to be communicated to the engine (i.e., through the intake valves of the intake manifold thereof) that is in fluid communication with outlet 32 of injector 26.

FIGS. 3-5 illustrate one preferred embodiment of fuel delivery system 10. In this embodiment, fuel rail 12 includes a receptor 36 affixed thereto. In a preferred embodiment, receptor 36 is formed of thermoplastic material, such as, for example, “polyamide 6”. It should be noted, however, that one of ordinary skill in the art will appreciate that other types of thermoplastic materials, such as those described above with respect to coating layer 24, could be used to construct receptor 36. Accordingly, the present invention is not limited to “polyamide 6”. The use of thermoplastic material for receptor 36 serves to facilitate a strong, non-leaking and non-permeable bond between receptor 36 and fuel rail 12 when the two components are coupled together.

With reference to FIG. 4, receptor 36 includes a flange 38, a fuel injector cup portion 40 and a flow channel 42. Flange 38, which includes a mating surface 44, is configured to allow for receptor 36 to be permanently affixed to the outer surface of fuel rail 12. As used herein, “permanently” means such affixation that contemplates the parts will not be separated during normal operating and maintenance. It is not contemplated that “permanently” means that it is impossible to remove or separate receptor 36 from fuel rail 12. Flange 38 is shaped so as to generally have the same contour or shape as the outer surface of fuel rail 12 to which receptor 36 is to be affixed. Accordingly, in the embodiment illustrated in FIGS. 3 and 4, flange 38 has a semi-circular or crescent shape to correspond to the cylindrical tube shape of fuel rail 12. In alternate exemplary embodiments wherein fuel rail 12 has a shape such as, for example, a rectangular tube, flange 38 will likewise have a similar complementary rectangular shape to allow for flange 38 and fuel rail 12 to be closely mated.

With continued reference to FIGS. 3 and 4, fuel injector cup portion 40 is configured to receive a portion of fuel injector assembly 14, and fuel injector 26 thereof, in particular. Flow channel 42 is configured to allow for the communication of fuel from feed 18 of fuel rail 12 to inlet 30 of injector 26, which, when assembled, is disposed within flow channel 42.

Irrespective of whether fuel rail 12 is a tube formed of metal or whether it is a thermoplastic coated tube, to assemble fuel rail 12 and receptor 36, flow channel 42 is aligned with feed 18 of fuel rail 12, and then the contact region between flange 38 (i.e., mating surface 44) and fuel rail 12 is heated to weld fuel rail 12 and flange 38 together. For example, in the embodiment wherein fuel rail 12 is a thermoplastic coated tube, polymer coating 24 of fuel rail 12 and the proximal surface material of flange 38 melt and intermix and weld together. The weld creates both a structural joint between receptor 36 and fuel rail 12, as well as a sealing joint to prevent, or at least reduce, the permeation of hydrocarbons or the leaking of fuel from fuel delivery system 10. In a preferred embodiment, the contact region is subjected to an induction welding process. However, other known processes, such as, for example, ultrasonic welding, hot plate welding or spin welding, to name a few, could also be used.

With reference to FIG. 4, in a preferred embodiment, in addition to flange 38, fuel injector cup portion 40, and flow channel 42, receptor 36 further comprises a cut notch 46 and a groove 48 formed in the outer surface of receptor 36, and fuel injector cup portion 40, in particular. As will be described in greater detail below, in this particular embodiment, fuel injector assembly 14 is configured to be permanently affixed to receptor 36, and therefore, fuel rail 12, and at least a portion of fuel injector assembly 14 is configured to be replaceable. Cut notch 46 is configured such that when injector 26 of injector assembly 14 needs to be replaced or serviced, receptor 36 can be cut through at cut notch 46 using, for example, a wheeled tube cutting tool, and injector assembly 14 can be extricated from receptor 36. In a preferred embodiment, cut notch 46 extends circumferentially around the body of receptor 36. Accordingly, it provides an adequate cutting sight from all approach angles. Groove 48 is configured to receive a fuel injector retention clip, and more specifically, a retention clip for a replacement injector that is inserted into cup 40 of receptor 36 after fuel injector assembly 14 is removed therefrom. Groove 48 may take any number of forms (e.g., circumferential, keyed, etc.) that are known in the art. Since groove 48 is used in connection with a replacement injector, it is located between cut notch 46 and flange 38 of receptor 36.

As briefly mentioned above, in this embodiment of fuel delivery system 10, injector assembly 14 is configured to be permanently affixed to receptor 36, and therefore, fuel rail 12. In order to facilitate such an arrangement, receptor 36 includes an engagement surface 50 that is disposed around the rim of cup portion 40. Fuel injector assembly 14 likewise includes an engagement flange 52, which, in a preferred embodiment, extends circumferentially around the outer housing of fuel injector assembly 14. However, it will be appreciated by those skilled in the art that flanges having other shapes and configurations could be used in place of the illustrated circumferential flange. In a preferred embodiment, engagement flange 52 is formed of thermoplastic material. For example, in one exemplary embodiment, flange 52 is formed of “polyamide 6”. Using this particular thermoplastic material serves to facilitate a strong, non-leaking and non-permeable bond between flange 52 and engagement surface 50 of receptor 36, which, in a preferred embodiment, is also formed of “polyamide 6”. It should be noted, however, that one of ordinary skill in the art will appreciate that other types of thermoplastic materials, such as those described above with respect to coating layer 24, could also be used to construct engagement flange 52.

To assemble fuel injector assembly 14 and receptor 36 together, injector assembly 14 is inserted into the cup portion 40 of receptor 36. Cup portion 40 is sized and configured such that inlet 30 of injector 26 is disposed within flow passage 42 of receptor 36 to allow for fuel to flow between feed 18 of fuel rail 12 and injector inlet 30. When assembled, engagement surface 50 of receptor 36 and engagement flange 38 of injector assembly 14 abut each other, engagement surface 50 and engagement flange 52 are heated such that the thermoplastic material forming engagement surface 50 and the proximal surface material of engagement flange 52 melt and intermix and weld together. This weld creates both a structural joint between receptor 36 and fuel injector assembly 14, as well as a sealing joint to prevent, or at least reduce, the permeation of hydrocarbons or the leaking of fuel from fuel delivery system 10, thereby obviating the need for O-rings between injector 26 and injector cup 40. In a preferred embodiment, the engagement surface 50 and engagement flange 52 are subjected to an induction welding process. However, other known processes, such as, for example, ultrasonic welding, hot plate welding, spin welding and various adhesives, to name a few, could also be used. The result of this process is a fuel delivery system 10 having a fuel injector assembly that is permanently affixed to the fuel rail.

As described above, if any part of fuel injector assembly 14 requires maintenance or replacement, receptor 36 is cut at cut notch 46. The cut is through the thermoplastic housing to the inner surface of cup 40 (i.e., injector 26 disposed within receptor 36 remains in tact) and extends circumferentially around the perimeter of receptor 36. Once cut, fuel injector assembly 14 can be removed. Accordingly, cut notch 46 is located between engagement surface 50 and flange 38 of receptor 36. Additionally, the location of cut notch 46 is such that the remaining cup portion 40 is of sufficient depth, size and configuration to receive a replacement injector assembly that is of the same or similar construction as fuel injector assembly 14 described above. However, one difference between the original fuel injector assembly 14 and the replacement injector assembly is that the replacement injector assembly is not welded to receptor 36, but rather abuts an outer surface of the rim of cup 40 and is held in place with a fuel injector retention clip, as described above.

With reference to FIGS. 6-8, an alternate preferred embodiment 10′ of fuel delivery system 10 is illustrated. In this embodiment, fuel injector assembly 14′ includes a one-piece outer housing 28′ that includes an integral flange portion 38′ configured to permanently affix fuel injector assembly 14′ to fuel rail 12. More particularly, flange 38′ comprises a mating surface 44′ that is configured to be permanently affixed to the outer surface of fuel rail 12, thereby permanently affixing fuel injector assembly 14′ to fuel rail 12. Accordingly, as opposed to the embodiment described above, this embodiment does not have a separate receptor 36 that is affixed to fuel rail 12 and that receives a portion of fuel injector assembly 14′. Rather, as will be described in greater detail below, fuel injector assembly 14′ is formed with a similar type of receptor 36′ that is of integral construction therewith.

As with flanged portion 38 described above, flange 38′ is shaped so as to have the same contour or shape as the outer surface of the fuel rail 12 to which fuel injector assembly 14 is to be affixed. Accordingly, in the embodiment illustrated in FIGS. 6-8, flange 38′ has a semi-circular or crescent shape to correspond to the cylindrical tube shape of fuel rail 12, thereby allowing flange 38′, and mating surface 44′ in particular, to be intimately mated with fuel rail 12. In alternate exemplary embodiments wherein fuel rail 12 has a shape such as, for example, a rectangular tube, flange 38′ will likewise have a similar complementary rectangular shape to allow for flange 38′ and fuel rail 12 to be closely mated.

In an exemplary embodiment, housing 28′ is formed of thermoplastic material that is molded over fuel injector 26 using known over-molding processes wherein dies are used to define the shape of housing 28′, including flange 38′. The arrangement of fuel injector 26 being disposed within a one piece housing 28′ serves to provide a seal between injector 26 and a corresponding cup formed within housing 28′ to prevent, or at least reduce, the permeation of hydrocarbons or the leaking of fuel from fuel delivery system 10′, thereby obviating the need for O-rings between injector 26 and the corresponding cup formed within housing 28′. In a preferred embodiment, housing 28′ is formed of “polyamide 6”, however, it should be noted that one of ordinary skill in the art will appreciate that other types of thermoplastic materials, such as those described above with respect to coating layer 24, could be used to construct housing 28′. As will be described in greater detail below, the use of a thermoplastic material for housing 28′, and more specifically flange 38′, serves to facilitate a strong, non-leaking and non-permeable bond between flange 38′ and fuel rail 12 when the two components are coupled together.

With reference to FIG. 7, when assembled to form fuel delivery system 10′, injector assembly 14′, and more specifically, flange 38′, is positioned on fuel rail 12 in a manner such that feed 18 of fuel rail 12 and flow passage 42′ of assembly 14′ are aligned. Since inlet 30 of injector 26 is disposed within flow channel 42′, inlet 30 and feed 18 are likewise aligned. Once in the appropriate position such that flange 38′ and fuel rail 12 are intimately mated, flange 38′ is permanently affixed to fuel rail 12. Irrespective of whether fuel rail 12 is a tube formed of metal or is a thermoplastic coated tube, in an exemplary embodiment the contact region between flange 38′ and fuel rail 12 is heated to weld fuel rail 12 and flange 38′ together. For example, in the embodiment wherein fuel rail 12 is a thermoplastic coated tube, polymer coating 24 of fuel rail 12 and the proximal surface material of flange 38′ melt and intermix and weld together. The weld creates both a structural joint between the fuel injector assembly 14′ and the fuel rail 12, as well as a sealing joint to prevent, or at least reduce, the permeation of hydrocarbons or the leaking of fuel from fuel delivery system 10′. In a preferred embodiment, the contact region is subjected to an induction welding process. However, other known processes, such as, for example, ultrasonic welding, hot plate welding, spin welding or various adhesives, to name a few, could also be used. Accordingly, one of ordinary skill in the art will recognize and appreciate that the present invention is not limited to only induction welding processes.

With continued reference to FIG. 7, a preferred embodiment of fuel injector assembly 14′ is depicted. In this embodiment, in addition to fuel injector 26 and outer housing 28′, fuel injector assembly 14′ further includes a cut notch 46 and a groove 48 formed in the outer surface of housing 28′; and an insert sleeve 54, a layer of thermoplastic material 56, and O-ring 58 all disposed within housing 28′.

In addition to being configured to be permanently affixed to fuel rail 12, at least a portion of fuel injector assembly 14 is configured to be replaceable. As illustrated in FIG. 7, outer housing 28′ has cut notch 46 disposed therein. Cut notch 46 is configured such that when housing 28′ is cut through at cut notch 46 using, for example, a wheeled tube cutting tool, fuel injector 26 can be extricated from housing 28′ without removing the entire assembly 14′ from fuel rail 12. As will be described in greater detail below, this allows for the servicing and/or replacement of the fuel injectors in fuel delivery system 10′ without disturbing the connection between fuel injector assembly 14′ and fuel rail 12. In a preferred embodiment, cut notch 46 extends circumferentially around housing 28′. A shown in FIG. 7, cut notch 46 is located slightly below the lowermost extent of insert sleeve 54 and extends circumferentially around housing 28′, thereby providing an adequate cutting sight from all approach angles. As will be described in greater detail below, this specific location of cut notch 46 allows for the creation of a properly sized injector cup (i.e., appropriate longitudinal depth) for a replacement injector when housing 28′ is cut at cut notch 46 (as described above) and injector 26 is removed therefrom.

In a preferred embodiment, fuel injector assembly 14′ further includes a groove 48 in housing 28′. Groove 48 is configured to receive a fuel injector retention clip. In the embodiment illustrated in FIGS. 6-8, wherein housing 28′ also includes cut notch 46, groove 48 is disposed between cut notch 46 and flange 38′. The purpose of groove 48 is to receive an injector retention clip for a replacement fuel injector that is inserted into a receptor 36′ that is left after housing 28′ is cut at cut notch 46 and injector 26 is removed. Accordingly, groove 48 may take any number of forms (e.g., circumferential, keyed, etc.) know in the art.

In a preferred embodiment, fuel injector assembly 14′ still further includes insert sleeve 54 that is disposed within housing 28′ and between a portion of injector 26 proximate inlet 30 and thermoplastic layer 56. Insert sleeve 54 is operative to serve as a spacer between injector 26 and layer 56, and, as will be described in greater detail below, is configured to be removed from housing 28′ when injector 26 is removed. In a preferred embodiment, insert sleeve 54 is formed of a polymeric material such as, for example, TEFLON®. However, in other alternate preferred embodiments, sleeve 54 is formed of materials such as stainless steel, polyphenylene sulfide (PPS), or any other high temperature tolerant material that will not melt during molding processes to which fuel injector assembly 14′ is subjected.

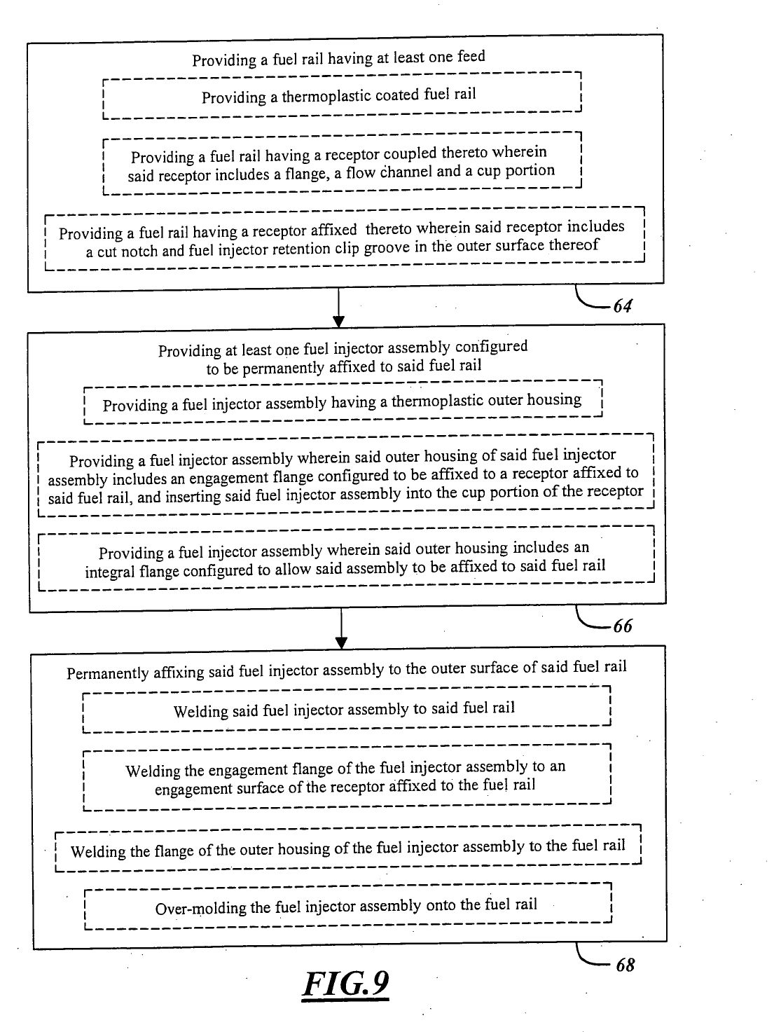

In a preferred embodiment, fuel injector assembly 14 yet still further includes thermoplastic layer 56 that is disposed within housing 28′ and between the inner surface of housing 28 and insert sleeve 54. As shown in FIGS. 7 and 8, a portion 60 of layer 56 also forms a portion of mating surface 44′ of flange 38′, thereby facilitating the permanent affixation of fuel injector assembly 14′ to fuel rail 12. Apart from assisting in the affixation of fuel injector assembly 14′ to fuel rail 12, layer 56 is also operative to form and define an injector cup 40′ (best shown in FIG. 8) configured to receive a replacement injector when injector 26 and sleeve 54 are removed from housing 28′. Accordingly, when injector 26 and sleeve 54 are removed, receptor 36′ remains affixed to fuel rail 12. In this embodiment, receptor 36′ includes a cup 40′ of sufficient size and shape (i.e., appropriate diameter and longitudinal depth) in which a replacement fuel injector can be inserted. Generally, layer 56 is comprised of a different thermoplastic material than that of housing 28′. In a preferred embodiment it is comprised of “polyamide 12” (commonly known as “PA 12” or “nylon 12”). One advantage to using “polyamide 12” is that it bonds well with the thermoplastic coating layer 24 of fuel rail 12, which, in a preferred embodiment, is also formed of “PA 12”. However, it should be noted that one of ordinary skill in the art will appreciate that other thermoplastic materials exist, such as, for example, “polyamide 11” and the other materials described above with respect to coating layer 24, that could be used to construct layer 56.

With continued reference to FIGS. 7 and 8, in a preferred embodiment, fuel injector assembly 14′ further includes O-ring 58. In the illustrated embodiment, O-ring 58 is disposed in a recess 62 in portion 60 of thermoplastic layer 56. O-ring 58 is positioned in such a way that it is in intimate contact with the outer surface of fuel rail 12 when fuel rail 12 and fuel injector assembly 14′ are bonded together. O-ring 58 serves as a seal for the joint between fuel injector assembly 14′ fuel rail 12, thereby preventing, or at least reducing, the leaking of fuel or the permeation of hydrocarbons therefrom. O-ring 58 further serves as a dam for welding flash that may be produced during the process in which fuel injector assembly 14′ is affixed to fuel rail 12. O-ring 58 is arranged and positioned such that it need not be replaced or removed when injector 26 (and sleeve 54) are removed from fuel injector assembly 14, and replaced with a replacement injector.

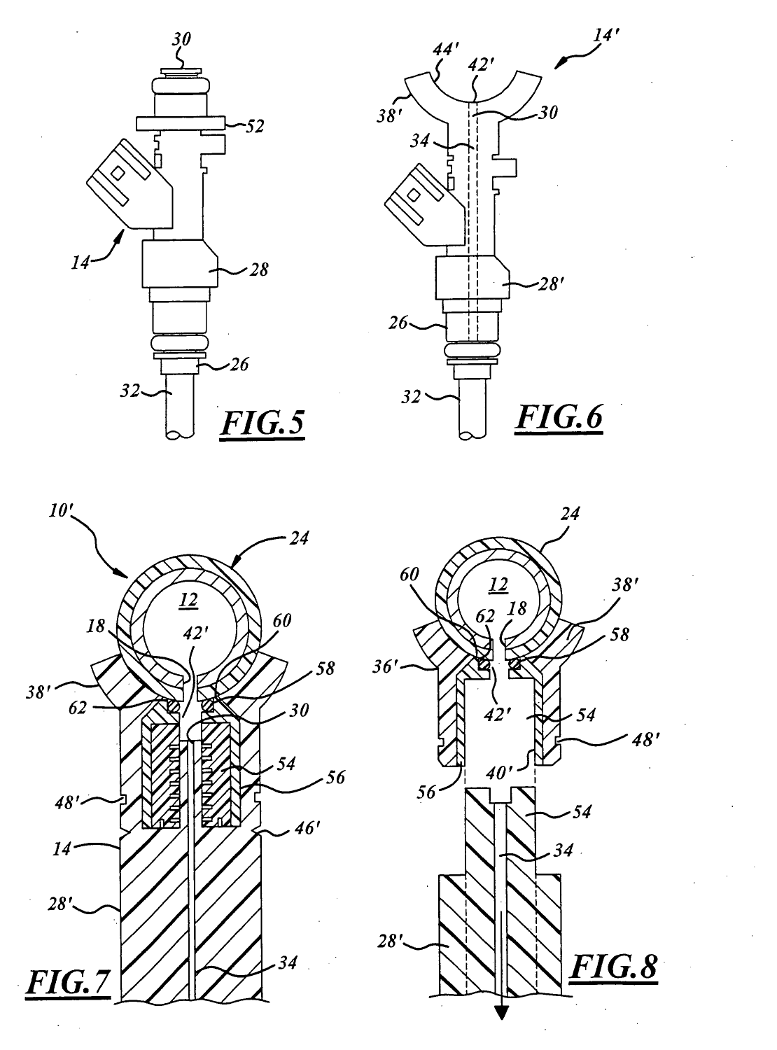

Accordingly, when the replacement of injector 26 is necessary, housing 28′ is cut at cut notch 46. The cut is only through the thermoplastic housing 28′, such that injector 26 is left in tact, and it extends circumferentially around the perimeter of housing 28′. The portion of housing 28′ that is on the opposite side of cut notch 46 from flange 38′ is pulled away from fuel rail 12. This causes fuel injector 26 to likewise be pulled away from fuel rail 12 and removed from fuel injector assembly 14′, and thus, fuel delivery system 10′. Once injector 26 is removed, sleeve 54 is then removed, thereby leaving behind receptor 36′, which includes a fuel injector cup 40′, that remains affixed to fuel rail 12 within which a replacement injector assembly (such as that illustrated in FIG. 5, for example) can be inserted. Accordingly, the location of cut notch 46 is such that the cup 40′ is of a sufficient depth, size and configuration to receive a replacement injector. When the replacement injector assembly is inserted into fuel injector cup 40′, a retention clip is inserted into groove 48 to assist in the retention of the replacement injector assembly in cup 40′.

It should be further noted that other methods exist by which fuel injector assembly 14 and injector 26, in particular, can be permanently affixed to fuel rail 12. For example, in an alternate embodiment wherein housing 28 does not include flange 38, fuel injector assembly 14 is over-molded onto fuel rail 12. In one such exemplary embodiment provided for exemplary purposes only, fuel rail 12 and fuel injector assembly 14 are arranged together, the connection point is then clamped over using a clamshell molding die, and then the connection is over-molded so as to create a permanent joint between fuel rail 12 and injector assembly 14. Accordingly, in this embodiment, flange 38 is essentially created during the process in which injector assembly 14 is affixed to fuel rail 12. In any event, the description above applies to this embodiment with equal force as that applied to the preferred embodiments above.

With reference to FIG. 9, an exemplary method of manufacturing a fuel delivery system is illustrated. In a first step 64, a fuel rail 12 having at least one feed 18 is provided. In an exemplary embodiment, fuel rail 12 is a thermoplastic coated tube comprising aluminum material. In a preferred embodiment, step 64 comprises providing a fuel rail 12 that includes an extruded core 20 comprised of an aluminum alloy and a coating layer 24 comprising a thermoplastic material such as “PA 12”. In a preferred embodiment, fuel rail 12 has a receptor 36 coupled thereto. Receptor 36 includes a flange 38, a flow channel 42 and a cup portion 40. In this embodiment, flange 38 is affixed to fuel rail 12 in such a way that flow channel 42 is aligned with feed 18 of fuel rail 12, and cup portion 40 is configured to receive a portion of a fuel injector assembly 14. In an exemplary embodiment receptor 36 further includes a cut notch and fuel injector retention clip groove in the outer surface thereof.

In a second step 66, at least one fuel injector assembly 14 is provided. Fuel injector assembly 14 is configured to be permanently affixed to fuel rail 12 so that feed 18 of fuel rail 12 is in fluid communication with an inlet 30 of the fuel injector 26, and at least a portion of fuel injector assembly 14 is configured to be replaceable. In an exemplary embodiment, housing 28 is comprised of a thermoplastic material, such as, for example, “PA 6”. In a preferred embodiment, step 66 comprises providing a fuel injector assembly 14 wherein the outer housing 28 of fuel injector assembly 14 includes an engagement flange 52 configured to be permanently affixed to an engagement surface 50 of a receptor 36 that is affixed to fuel rail 12. In an alternate preferred embodiment, step 66 includes providing a fuel injector assembly 14 wherein the outer housing 28 thereof includes an integral flange 38 configured to be permanently affixed to fuel rail 12, as well as both a cut notch 46 and groove 48 disposed therein.

In a third step 68, fuel injector assembly 14 is permanently affixed to the outer surface of fuel rail 12. In a preferred embodiment in which receptor 36 is affixed to fuel rail 12, flange 52 of fuel injector assembly 14 is welded onto engagement surface 50 of receptor 36. In an exemplary embodiment, both engagement surface 50 and engagement flange 52 are formed of thermoplastic materials. In an alternate preferred embodiment wherein fuel injector assembly 14 includes integrally formed flange 38, flange 38 is welded directly onto fuel rail 12. In an exemplary embodiment, flange 38 and fuel rail 12 comprise thermoplastic material. In yet another alternate embodiment, fuel injector assembly 14 is over-molded onto fuel rail 12. In each of these embodiments any one of a number of welding processes can be employed, such as, for example, induction welding, ultrasonic welding, hot plate welding or spin welding, to name a few, can be used.

While the invention has been particularly shown and described with reference to the preferred embodiments thereof, it is well understood by those skilled in the art that various changes and modifications can be made in the invention without departing from the spirit and scope of the invention.

1. A fuel delivery system comprising:
a fuel rail having at least one feed; and
at least one fuel injector assembly comprising a fuel injector and an outer housing, wherein said fuel injector assembly is permanently affixed to said fuel rail so that said feed of said fuel rail is in fluid communication with an inlet of said fuel injector, and further wherein said fuel injector assembly is further configured such that at least a portion thereof is replaceable.

2. A fuel delivery system in accordance with claim 1 wherein said fuel rail is a thermoplastic coated tube and said housing of said fuel injector assembly comprises thermoplastic material, and further wherein said fuel injector assembly being configured to be welded to said fuel rail.

3. A fuel delivery system in accordance with claim 1 wherein said fuel rail is a metal tube and said fuel injector assembly is configured to be welded to said fuel rail.

4. A fuel delivery system in accordance with claim 1 further comprising a receptor configured to be permanently affixed to said fuel rail, said receptor including a flange, a flow channel and a fuel injector cup portion, wherein said flow channel is configured to be aligned with said feed of said fuel rail when said receptor is affixed thereto, and said cup portion is configured to receive a portion of said fuel injector assembly.

5. A fuel delivery system in accordance with claim 4 wherein said flange is configured to be welded to said fuel rail.

6. A fuel delivery system in accordance with claim 5 wherein said fuel rail is a thermoplastic coated tube and said flange of said receptor comprises thermoplastic material.

7. A fuel delivery system in accordance with claim 4 wherein said inlet of said fuel injector is disposed within said flow channel in said receptor when said fuel injector assembly is inserted within said fuel injector cup portion such that said feed of said fuel rail and said fuel injector inlet are in fluid communication with each other.

8. A fuel delivery system in accordance with claim 4 wherein said fuel injector assembly further includes an engagement flange configured to be affixed to said receptor.

9. A fuel delivery system in accordance with claim 8 wherein said receptor includes an engagement surface and said engagement flange of said fuel rail assembly is welded to said engagement surface.

10. A fuel delivery system in accordance with claim 9 wherein said engagement surface and said engagement flange both comprise thermoplastic material.

11. A fuel delivery system in accordance with claim 4 wherein said receptor further includes a cut notch in the outer housing thereof, said cut notch configured such that when said receptor is cut at said cut notch, said fuel injector assembly inserted within and affixed to said receptor can be removed from said receptor, thereby exposing said injector cup that is configured to receive a replacement fuel injector assembly.

12. A fuel delivery system in accordance with claim 11 wherein said receptor further includes a groove in the outer housing thereof, said groove configured to receive a portion of a fuel injector retention clip for said replacement fuel injector assembly.

13. A fuel delivery system in accordance with claim 1 wherein said housing further includes a flange and a flow channel therein, said flange being configured to be affixed to said fuel rail and said flow channel being configured to be aligned with said feed of said fuel rail when said flange is affixed to said fuel rail.

14. A fuel delivery system in accordance with claim 13 wherein said inlet of said fuel injector is disposed within said flow channel such that said fuel injector inlet and said fuel rail feed are in fluid communication when said flange is affixed to said fuel rail.

15. A fuel delivery system in accordance with claim 13, wherein said housing further includes a cut notch therein configured such that when said housing is cut at said cut notch, a portion of said fuel injector assembly can be removed from said housing, thereby leaving a receptor affixed to said fuel rail that includes an injector cup configured to receive a replacement fuel injector wherein said receptor is formed of the portion of said fuel injector assembly that remains affixed to said fuel rail.

16. A fuel delivery system in accordance with claim 15 wherein said receptor remaining affixed to said fuel rail includes a groove therein configured to receive a portion of a fuel injector clip of said replacement injector.

17. A fuel delivery system in accordance with claim 15 wherein said fuel injector assembly further includes an insert sleeve disposed within said housing between a portion of said fuel injector proximate said fuel injector inlet, and the inner surface of said housing, said sleeve serving as a spacer so that when said fuel injector and said sleeve are removed from said housing, said remaining injector cup is of suitable size to receive said replacement injector.

18. A fuel delivery system in accordance with claim 15 wherein said fuel injector assembly further includes a layer of thermoplastic material disposed between a portion of said fuel injector proximate said fuel injector inlet and the inner surface of said housing, said thermoplastic layer configured to define said fuel injector cup.

19. A fuel delivery system in accordance with claim 13 wherein said housing of said fuel injector assembly comprises thermoplastic material.

20. A fuel delivery system in accordance with claim 13 wherein said fuel rail is a thermoplastic coated tube comprising aluminum material.

21. A fuel delivery system in accordance with claim 13 wherein said fuel rail and said flange of said fuel injector assembly are welded together.

22. A fuel delivery system in accordance with claim 21 wherein said fuel rail is a thermoplastic coated tube and said flange of said housing comprises thermoplastic material, said flange being welded to said thermoplastic coated fuel rail.

23. A fuel delivery system in accordance with claim 1 wherein said fuel injector assembly is over-molded onto said fuel rail.

24. A fuel injector assembly comprising:
a fuel injector; and
an outer housing in which said fuel injector is disposed, a portion of said outer housing configured to be permanently affixed to a fuel rail.

25. A fuel injector assembly in accordance with claim 24 wherein said fuel injector assembly is configured to be inserted into a receptor affixed to said fuel rail and said fuel injector assembly includes an engagement flange configured to be engaged with a corresponding engagement surface of said receptor.

26. A fuel injector assembly in accordance with claim 25 wherein said engagement flange is configured to be welded to said engagement surface.

27. A fuel injector assembly in accordance with claim 25 wherein each of said engagement flange and said engagement surface are formed of thermoplastic material.

28. A fuel injector assembly in accordance with claim 24 wherein said outer housing includes a flange configured to allow said fuel injector assembly to be permanently affixed to said fuel rail.

29. A fuel injector assembly in accordance with claim 28 wherein said flange comprises thermoplastic material, and said fuel rail is a thermoplastic coated tube.

30. A fuel injector assembly in accordance with claim 24 wherein said housing further includes a cut notch therein configured such that when said fuel injector assembly is affixed to said fuel rail, and when said housing is cut at said cut notch, a portion of said fuel injector assembly can be removed from said housing leaving a receptor affixed to said fuel rail that includes a fuel injector cup configured to receive a replacement fuel injector, wherein said receptor is formed of the portion of said fuel injector assembly that remains affixed to said fuel rail.

31. A fuel injector assembly in accordance with claim 30 further including an insert sleeve disposed within said housing between a portion of said fuel injector proximate said inlet and the inner surface of said housing, said sleeve configured to be a spacer such that when said fuel injector assembly is affixed to said fuel rail, and said housing is cut at said cut notch, said fuel injector and said sleeve can be removed from said housing thereby leaving an injector cup of suitable size to receive said replacement injector.

32. A fuel injector assembly in accordance with claim 31 wherein said outer housing further includes a groove therein configured to receive a portion of a fuel injector clip for a replacement fuel injector.

33. A fuel injector assembly in accordance with claim 31 further including a layer of thermoplastic material disposed between a portion of said fuel injector proximate said inlet, and the inner surface of said housing configured to define said fuel injector cup.

34. A fuel injector assembly in accordance with claim 24 wherein said housing comprises thermoplastic material.

35. A method of manufacturing a fuel delivery system, comprising the steps of:
providing a fuel rail having at least one feed;
providing at least one fuel injector assembly configured to be permanently affixed to said fuel rail so that said feed of said fuel rail is in fluid communication with an inlet of said fuel injector, and wherein at least a portion of said fuel injector assembly is configured to be replaceable; and
permanently affixing said fuel injector assembly to the outer surface of said fuel rail.

36. A method in accordance with claim 35 wherein:
said providing a fuel rail step comprises providing a thermoplastic coated fuel rail;
said providing a fuel injector assembly step comprises providing a fuel injector assembly having a thermoplastic outer housing; and
said affixing step comprises welding said fuel injector assembly to said fuel rail.

37. A method in accordance with claim 35 wherein:
said providing a fuel rail step comprises providing a fuel rail having a receptor coupled thereto wherein said receptor includes a flange, a flow channel and a cup portion, and further wherein said flange is configured to be permanently affixed to said fuel rail, said flow channel is configured to be aligned with said feed of said fuel rail when said flange is affixed to said fuel rail, and said cup portion is configured to receive said fuel injector assembly;
said providing a fuel injector assembly comprises providing a fuel injector assembly wherein said outer housing of said fuel injector assembly includes an engagement flange configured to be affixed to said receptor; and
said affixing step comprises welding said engagement flange to an engagement surface of said receptor.

38. A method in accordance with claim 37 wherein said providing a fuel rail step further comprises providing a fuel rail having said receptor affixed thereto wherein said receptor includes a cut notch and a fuel injector retention clip groove formed in the outer surface thereof.

39. A method in accordance with claim 35 wherein said providing a fuel injector assembly step comprises providing a fuel injector assembly wherein said outer housing includes an integral flange configured to allow said fuel injector assembly to be permanently affixed to said fuel rail; and
wherein said affixing step comprises welding said flange to said outer surface of said fuel rail using an induction welding process.

40. A method in accordance with claim 35 wherein said affixing step comprises over-molding said fuel injector assembly onto said fuel rail.
